(19) United States
(12) Patent Application Publication
(10) Pub. No.: US 2023/0091360 A1
(43) Pub. Date: Mar. 23, 2023

(54) INFORMATION PROCESSING APPARATUS, INFORMATION PROCESSING METHOD AND RECORDING MEDIUM

(71) Applicant: CASIO COMPUTER CO., LTD., Tokyo (JP)

(72) Inventor: Yoshiyuki KATO, Tokyo (JP)

(21) Appl. No.: 17/943,774

(22) Filed: Sep. 13, 2022

(30) Foreign Application Priority Data
Sep. 17, 2021 (JP) 2021-152121

(51) Int. Cl. G06F 21/32; G08B 21/00

(52) U.S. Cl. CPC G06F 21/32; G08B 21/00

(57) ABSTRACT

Provided is an information processing apparatus comprising at least one processor, the at least one processor configured to execute a first authentication process at a first authentication level based on first biometric information about a user acquired at a first timing; instruct the information processing apparatus to operate in a first operation mode in a case where a result of the first authentication process reaches the first authentication level, and the user corresponding to the first biometric information is judged to have first operation authority; execute a second authentication process at a second authentication level lower than the first authentication level, based on second biometric information about the user acquired at a second timing during the operation in the first operation mode; and execute a process according to a result of the second authentication process.

### CROSS-REFERENCE TO RELATED APPLICATIONS

This application is based on and claims the benefit of priority from Japanese Patent Application No. 2021-152121, filed on 17 Sep. 2021, the content of which is incorporated herein by reference.

### BACKGROUND

### Technical Field

The present disclosure relates to an information processing apparatus, an information processing method and a recording medium.

### Related Art

There is a known technology for performing personal authentication using biometric information specific to each individual to execute management of entry/exit to/from a particular area, management of login to a particular system and the like based thereon. For example, Japanese Unexamined Patent Application Publication No. 2020-144762 discloses a technique which relates to an information system having a login function, and according to which an image of a user is captured with a camera, a face authentication of the user is performed based on a video signal from the camera and, automatically logs out when the user face authentication cannot be performed.

### SUMMARY

One aspect of the present disclosure is directed to an information processing apparatus including at least one processor. The at least one processor is configured to execute a first authentication process at a first authentication level based on first biometric information about a user acquired at a first timing; instruct the information processing apparatus to operate in a first operation mode in a case where a result of the first authentication process reaches the first authentication level and the user corresponding to the first biometric information is judged to have first operation authority; execute a second authentication process at a second authentication level lower than the first authentication level, based on second biometric information about the user acquired at a second timing during the operation in the first operation mode; and execute a process according to a result of the second authentication process.

### BRIEF DESCRIPTION OF THE DRAWINGS

FIG. 1 is a system configuration diagram exemplifying a configuration of a camera management system according to one embodiment of the present disclosure;

FIG. 2 is a block diagram exemplifying a configuration of hardware and functional blocks of a camera management apparatus according to the one embodiment of the present disclosure;

FIG. 3 is a flowchart exemplifying a flow of an authentication process and mode-specific control processes based thereon according to the one embodiment of the present disclosure;

FIG. 4 is a flowchart exemplifying a flow of an operation mode control process according to the one embodiment of the present disclosure;

FIG. 5 is a diagram showing an example of a positive authentication operation screen according to the one embodiment of the present disclosure;

FIG. 6 is a diagram showing an example of a higher mode operation screen according to the one embodiment of the present disclosure; and

FIG. 7 is a diagram showing an example of a general mode operation screen according to the one embodiment of the present disclosure.

### DETAILED DESCRIPTION OF THE EMBODIMENTS

The present disclosure will be described below on the basis of embodiments thereof, with reference to accompanying drawings.

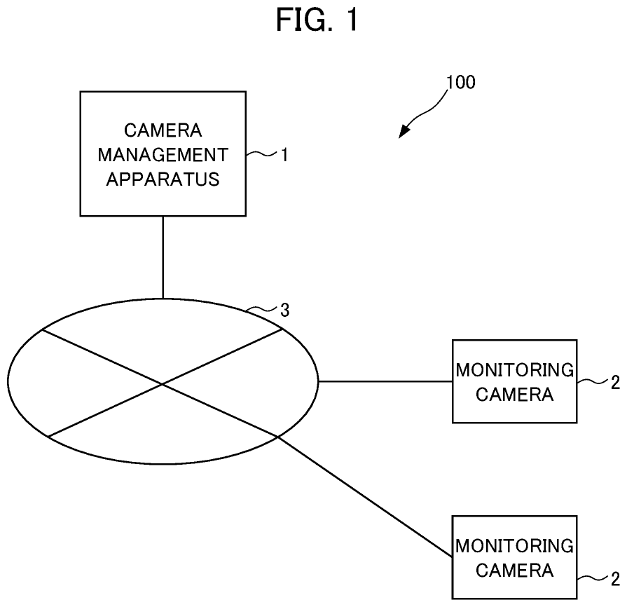

FIG. 1 is a system configuration diagram exemplifying a system configuration of a camera management system 100 according to one embodiment of the present disclosure. As shown in FIG. 1, the camera management system 100 is provided with a camera management apparatus 1 as an information processing apparatus and at least one monitoring camera 2.

The camera management apparatus 1 and the monitoring camera 2 are mutually communicably connected via a network 3. The network 3 is configured with a wired or wireless communication line enabling secure communication, for example, an exclusive line or a local area network (LAN). In the present embodiment, an on-premises monitoring system introduced in a commercial facility such as a convenience store or a supermarket is assumed as a use case of the camera management system 100. The camera management system 100, however, is not limited thereto but is applicable as an on-premises monitoring system in various kinds of offices, factories and the like.

The camera management apparatus 1 is an apparatus for performing operation setting, operation control and on/off control, and is provided with a function of executing a process for authentication for a user to log in to a system based on biometric information about the user. The camera management apparatus 1 is typically realized by electronic equipment such as a server apparatus or a personal computer provided with a browser function. In the present embodiment, a face image is used as the biometric information described above.

The monitoring camera 2 is imaging means including a circuit unit provided with an imaging device such as a CCD and an image processing function, and is provided with a configuration of a general digital video camera. Each monitoring camera 2 is provided with a communication circuit unit for communicating with the camera management apparatus 1 via the network 3.

One or more monitoring cameras 2 can be installed in the camera management system 100 as necessary. For example, when the camera management apparatus 1 is introduced into a convenience store, the camera management apparatus 1 is installed in the back office, and a plurality of monitoring cameras 2 are installed in a monitoring target area of the selling area so as to avoid a blind spot. Additionally, monitoring cameras 2 may be provided in rooms different from the room where the camera management apparatus 1 is installed, as necessary.

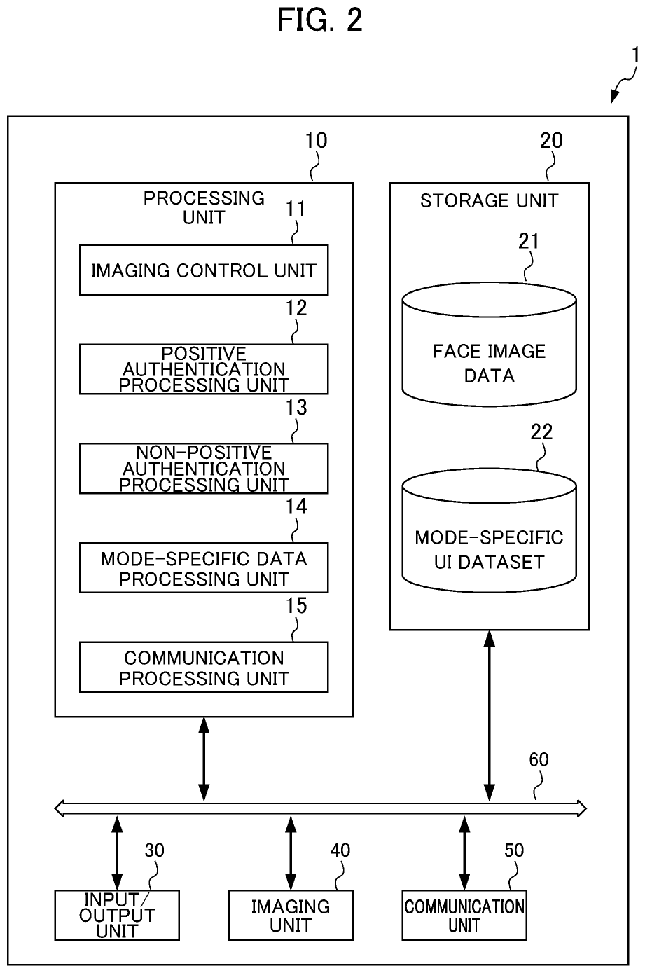

Next, a configuration of the camera management apparatus 1 will be described. FIG. 2 is a block diagram exemplifying a configuration of hardware and functional blocks of the camera management apparatus 1 according to the one embodiment of the present disclosure.

As shown in FIG. 2, the camera management apparatus 1 is an information processing apparatus such as a server or a personal computer, and is provided with a processing unit 10, a storage unit 20, an input/output unit 30, an imaging unit 40 and a communication unit 50. The processing unit 10, the storage unit 20, the input/output unit 30, the imaging unit 40 and the communication unit 50 are connected via a bus 60 as an internal communication line.

The processing unit 10 is an arithmetic device configured with at least one processor such as a CPU. The processing unit 10 reads various kinds of programs and data from the storage unit 20 described later to realize the functions of the camera management apparatus 1. In the present embodiment, the processing unit 10 executes data processing of each of the functional units of an imaging control unit 11, a positive authentication processing unit 12, a non-positive authentication processing unit 13, a mode-specific data processing unit 14 and a communication processing unit 15. Operation of each functional unit will be described later.

The storage unit 20 is a storage area for various kinds of programs for causing hardware resources to function as the camera management apparatus 1 and various kinds of data, and can be configured with a ROM, a RAM, a flash memory, a semiconductor drive (SSD) or a hard disk drive (HDD). Specifically, the storage unit 20 stores a program for causing the processing unit 10 to execute each function of the present embodiment (a control program for the camera management apparatus 1), various kinds of parameters, externally inputted operation input data, display data created by the mode-specific data processing unit 14 described later, face image data 21 used for a face recognition process and a user interface dataset 22 displayed according to an operation mode of the camera management apparatus 1.

The input/output unit 30 is configured with various kinds of input devices, such as a keyboard, a mouse, a touch panel and a microphone, enabling data to be externally inputted to the camera management apparatus 1 and output devices, such as a monitor display for outputting and displaying image data received from the monitoring camera 2, mode-specific user interface screens generated by the mode-specific data processing unit 14 and a speaker.

The imaging unit 40 is provided with an imaging device such as a CCD and an image processing engine, and is mainly used to capture a front face image of a user to be used to perform a positive authentication process using the face image described later. The imaging unit 40 is typically a video camera that is generally provided in a personal computer. The positive authentication process described above may be executed using the monitoring camera 2. In that case, a user as a target of face authentication turns his face to the monitoring camera 2 so that a front face image can be picked up for the positive authentication process. In the case of performing the positive authentication process by the monitoring camera 2, such a configuration may be made that a biometric motion for live authentication, such as moving a face at the time of authentication, is required in order to avoid influence of another misleading image existing within the angle of view (for example, a face image on a poster included in the background). Further, a predetermined key-in operation or another device such as an IC card may be used together with the positive authentication process.

The communication unit 50 is a communication module that performs transmission/reception of various kinds of data, such as image data, monitoring camera control data and monitoring camera status data, to/from the monitoring camera 2 and is configured as hardware, for example, a network interface card (NIC).

Next, a function of the camera management apparatus 1 realized by each program executed by the processing unit 10 will be described.

The imaging control unit 11 has a function of generating pieces of control data for the imaging unit 40 and the monitoring camera 2 based on operation instructions to the imaging unit 40 and the monitoring camera 2 inputted through the input/output unit 30 and transmitting the pieces of control data to the imaging unit 40 and the monitoring camera 2, respectively. As the operation instruction to the imaging unit 40, start/stop of the imaging unit 40 to acquire a face image in the positive authentication process described later is given. As the operation instruction to the monitoring camera 2, start/stop of the monitoring camera 2, start/stop of recording, change of the focal distance, change of the angle of view, iris (aperture) setting, setting for light source flicker, or the like is given.

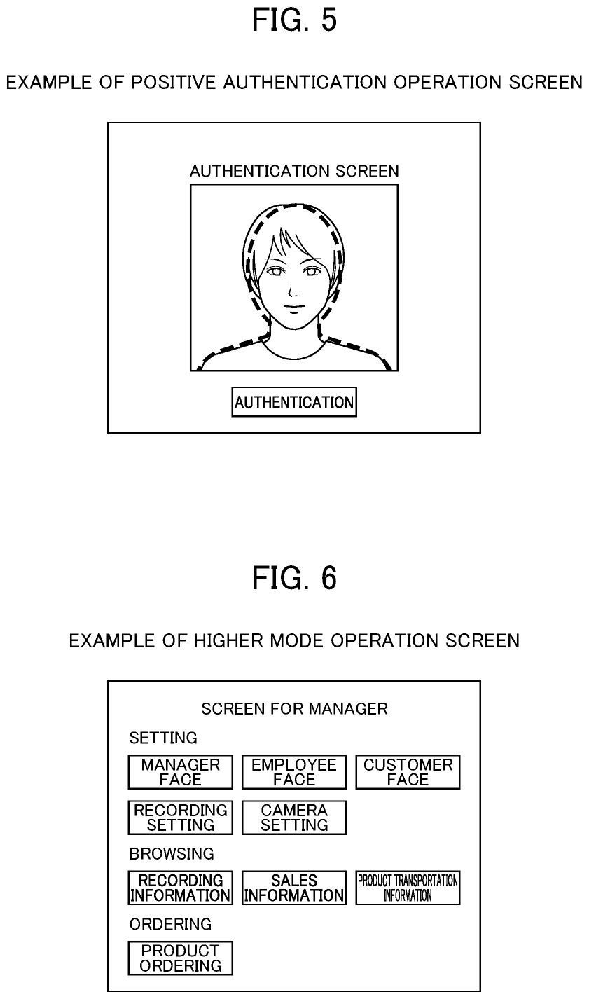

The positive authentication processing unit 12 executes an authentication process of comparing a face image of a user acquired by the imaging unit 40 with the face image data 21 of users targeted by the authentication process, which has been stored in a database of the storage unit 20 in advance, to judge whether they correspond to each other or not and, if they correspond, approving the user to log in to the camera management system 100 and perform an operation in a corresponding operation mode. This positive authentication process is a first authentication process executed at the time of login as a first timing. Here, the positive authentication process is a process of performing operation of acquiring a front face image of a process target user in a stationary state as first biometric information by the imaging unit 40, comparing the front face image with the face image data 21 that has been similarly acquired in advance to judge whether both correspond to each other or not and, if both correspond, allowing the target user to log in. The judgment whether the pieces of face image data correspond or not is performed by comparing pieces of feature data of the picked-up face image and the stored face image data 21. As known, feature data is acquired, for example, based on a distance between eyes, a nose width, an eye socket depth, a chin contour and the like. With the face image data 21 of each user, operation authority granted to the user is associated as first operation authority or second operation authority that is limited more than the first operation authority. If the user is judged to have the first operation authority, a first operation mode is set as the operation mode of the camera management apparatus 1. If the user is judged to have the second operation authority, a second operation mode is set. Therefore, a user who is authenticated and allowed to log in can operate the camera management apparatus 1 in an operation mode that the user is allowed. The authentication process by the positive authentication processing unit 12 can be regarded as an authentication process at a first authentication level at which the recognition rate is relatively high. When the positive authentication processing unit 12 judges that an authentication target user wears a mask, face recognition using features based on shape dimensions around both eyes may be executed. FIG. 5 shows an operation screen example in the case of performing the positive authentication process. Such an operation screen can be displayed, for example, when the camera management apparatus 1 is started or when a camera management application of the camera management apparatus 1 is started. On an authentication screen, a guide frame for capturing a face image is shown in a form like a face contour line, for example, and a user who is going to be authenticated can operate an authentication button after adjusting his own face image to the guide frame, facing the imaging unit 40 of the camera management apparatus 1.

For a user who has cleared the positive authentication process and is in a login state, the non-positive authentication processing unit 13 subsequently continuously performs image acquisition by the imaging unit 40 and the monitoring camera 2, and performs a process of judging whether or not the user in the login state is continuously in a state of satisfying a predetermined condition, based on the image. This non-positive authentication process is a second authentication process executed at a second authentication level lower than the first authentication level in a login state as a second timing. In comparison with the positive authentication process that performs face recognition based on a front face image in a state of facing the imaging unit 40 or any monitoring camera 2, the non-positive authentication process is different from the positive authentication process in that face recognition is basically performed using video data captured by the imaging unit 40 or each monitoring camera 2. By using the video data as second biometric information, it is possible to continuously execute the face recognition process based on the face image data 21 of the user in the login state. However, the recognition rate is lower than the positive recognition process. That is, the non-positive authentication process can be regarded as an authentication process in which a face recognition process at the second authentication level lower than the first authentication level of the positive authentication process is performed. In the non-positive authentication process, a form of an auricle or the like can be added and used as characteristics of a face that the feature data described before is based on. By using a form of an auricle, it is expected that the recognition rate in a state in which a target user faces sideways relative to a camera increases in the non-positive authentication process.

The mode-specific data processing unit 14 is a functional unit that executes a process for causing the camera management apparatus 1 to operate in an operation mode corresponding to a result of authentication by the positive authentication processing unit 12 and the non-positive authentication processing unit 13. In the present embodiment, operation modes are classified in three classifications of a higher mode as the first operation mode, a general mode as the second operation mode and a non-operation mode. The non-operation mode is an operation mode in which a user interface screen required to operate the monitoring camera 2 is not displayed on the camera management apparatus 1. In this operation mode, a user cannot access any function of the camera management apparatus 1. Separate user interface datasets (hereinafter “UI datasets”) are prepared for the higher mode and the general mode, respectively. These UI datasets are stored in the storage unit 20 in advance as mode-specific UI datasets 22.

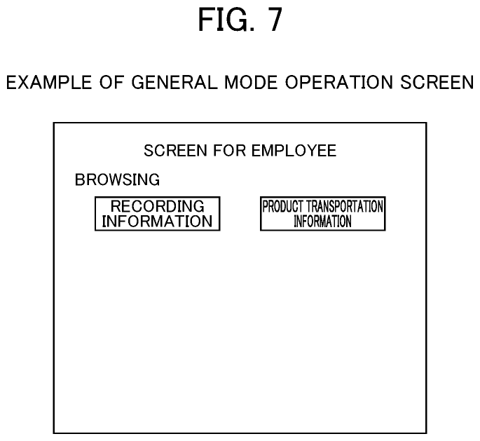

FIGS. 6 and 7 show a display example of a higher mode operation screen and a display example of a general mode operation screen, respectively. Each of these screens is displayed after operation authority of a user is judged by positive authentication at the time of login.

On the higher mode operation screen example in FIG. 6, a screen for manager of a convenience store or the like is exemplified. The screen for manager enables access to items about the management functions of the monitoring camera 2 and items about store sales, such as setting items by which face settings for manager, employee or customer, recording settings for the monitoring camera 2, settings for various kinds of functions of the camera and the like can be made, browsing items of “recording information” by which a recorded image can be browsed, “sales information”, “product transportation information” and the like, an ordering items by which product ordering can be performed, and the like. In comparison, the general mode operation screen example exemplified in FIG. 7 is configured so that only the browsing items of “recording information” and “product transportation information” are displayed, and the other items displayed in the higher mode operation screen example are masked. By further limiting operation authority for a user allowed to log in according to an authentication level the user belongs to as described above, it is possible to mitigate security problems such as an important setting being inadvertently changed through the camera management apparatus 1, and information about store sales being unnecessarily browsed.

The communication processing unit 15 executes a process for data transmission/reception between the monitoring camera 2 and other external apparatuses, and the camera management apparatus 1 via the communication unit 50.

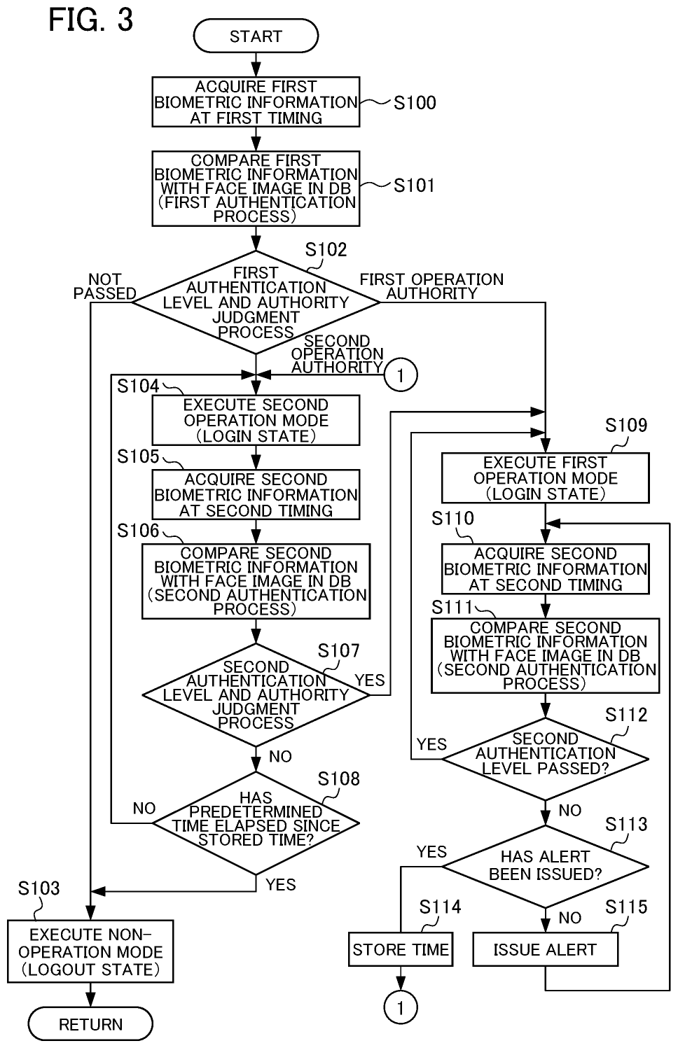

Next, description will be made on a flow of a login authentication process by the camera management apparatus 1 having the configuration described above with reference to FIG. 3. FIG. 3 is a flowchart exemplifying the flow of the login authentication process by the camera management apparatus 1 of the present embodiment.

Data processing exemplified in FIG. 3 is started, for example, by an operation of opening an application provided with a camera management function in a state in which the camera management apparatus 1 has been started. The positive authentication processing unit 12 acquires a face image of a user, which is the first biometric information, at the first timing by the imaging unit 40 (step S100) and compares the face image with the face image data 21 stored in the database of the storage unit 20 (the first authentication process) (step S101). At step S102, the positive authentication processing unit 12 makes a judgment about the face image at the first authentication level and performs an authority judgment process. If it is judged that there is no face image data that passes the first authentication level (step S102: “not passed”), the positive authentication processing unit 12 causes the mode-specific data processing unit 14 to execute operation in the non-operation mode (step S103). In this case, the camera management apparatus 1 ends the login authentication process in a state in which the camera management function is not operated.

At the face image judgment at step S102, if the user passes the authentication process at the first authentication level and is judged to have the first operation authority (manager authority), which is the authority to operate the camera management apparatus 1 in the higher mode (a manager mode) (step S102: “first operation authority”), the positive authentication processing unit 12 causes the mode-specific data processing unit 14 to execute operation in the higher mode which is the first operation mode (step S109), and the user is placed into a login state (the second timing). In this case, the UI of the higher mode in FIG. 5 is displayed on the camera management apparatus 1. After that, for the user in the login state, the non-positive authentication processing unit 13 acquires a moving image of the user as the second biometric information (step S110) and executes the second authentication process of comparing the moving image with the face image stored in the database in the storage unit 20 at the second authentication level (step S111). If it is judged in the second authentication process (the non-positive authentication process) that a user having the first operation authority (the manager authority) has been detected, that is, if the user is judged to have passed the second authentication level (step S112: YES), the mode-specific data processing unit 14 continuously executes the higher mode (step S109). If it is judged at step S112 by the second authentication process that a user having the first operation authority (the manager authority) has not been detected, that is, if the user is judged not to pass the second authentication level (step S112: NO), the non-positive authentication processing unit 13 judges whether an alert indicating that the operation mode is to be changed from the higher mode to the general mode has been issued at step S112 or not (step S113). If it is judged that the alert has not been issued (step S113: NO), the non-positive authentication processing unit 13 issues the alert (step S115) and returns to step S110 to acquire the second biometric information. If it is judged at step S113 that the alert has been issued (step S113: YES), the non-positive authentication processing unit 13 stores the time of the judgment (step S114) and transitions to step S104. At the process of step S112, the operation mode may be changed to the general mode not according to the detection result of the non-positive authentication result but by the target user being outside the angle of view.

In the authority judgment process at the first authentication level at step S102, if the user is judged to have passed the authentication process at the first authentication level and have the second operation authority, which is the authority to operate the camera management apparatus 1 in the general mode (step S102: “second operation authority”), the positive authentication processing unit 12 causes the mode-specific data processing unit 14 to execute operation in the general mode (step S104), and the user is placed into the login state (the second timing). In this case, the UI of the general mode in FIG. 6 is displayed on the camera management apparatus 1. After that, for the user in the login state, the non-positive authentication processing unit 13 acquires a moving image of the user as the second biometric information (step S105) and executes the second authentication process of comparing the moving image with the face image stored in the database in the storage unit 20 at the second authentication level (step S106). If it is judged in the second authentication process (the non-positive authentication process) that a user having the first operation authority (the manager authority) has been detected, that is, if the user is judged to have passed the second authentication level (step S107: YES), the non-positive authentication processing unit 13 causes the mode-specific data processing unit 14 to execute operation in the higher mode (step S109). This is intended to improve the convenience for a user while maintaining security even if the user in a login state is changed to the general mode. The user is enabled to perform an operation in the higher mode again if the user is successful in the non-positive authentication process, which is the second authentication process, without the necessity to perform the positive authentication process, which is the first authentication process, again.

On the other hand, if it is judged at step S107 that a user having the first operation authority (the manager authority) has not been detected, that is, if the user is judged not to pass the second authentication level (step S107: NO), the non-positive authentication processing unit 13 judges whether or not, in that state, a predetermined time has elapsed since the time stored at step S114, that is, the time when it was judged at S113 that the alert had been issued (step S108). Until the predetermined time has elapsed (step S108: NO), the non-positive authentication processing unit 13 continuously causes the mode-specific data processing unit 14 to operate in the general mode (step S104). If it is judged that the predetermined time has elapsed (step S108: YES), the non-positive authentication processing unit 13 causes the process to transition to step S103 and causes the mode-specific data processing unit 14 to execute the non-operation mode.

According to the above face image authentication process, it is possible to cause the camera management apparatus 1 to operate in an appropriate operation mode corresponding to a user, according to a result of the positive authentication process. Further, for a user who has logged in in the higher mode once, it is possible to continuously keep the login state by the non-positive authentication process at a different authentication level. Further, since an alert is issued if a user in the higher mode who is in a login state does not pass the second authentication process (the non-positive authentication process), the user can know in advance that the operation mode may be changed from the higher mode to the general mode because the user has not passed the second authentication level. Even if an operation mode for a user is changed from the higher mode to the general mode by the non-positive authentication process, the user is enabled to perform an operation in the higher mode if the user is successful in the non-positive authentication process afterward. Further, if a user who passes the second authentication level is not detected even if a predetermined time elapses after issuance of an alert, the mode-specific data processing unit 14 causes the operation mode of the camera management apparatus 1 to transition to the non-operation mode, and, therefore, security of the camera management apparatus 1 can be maintained.

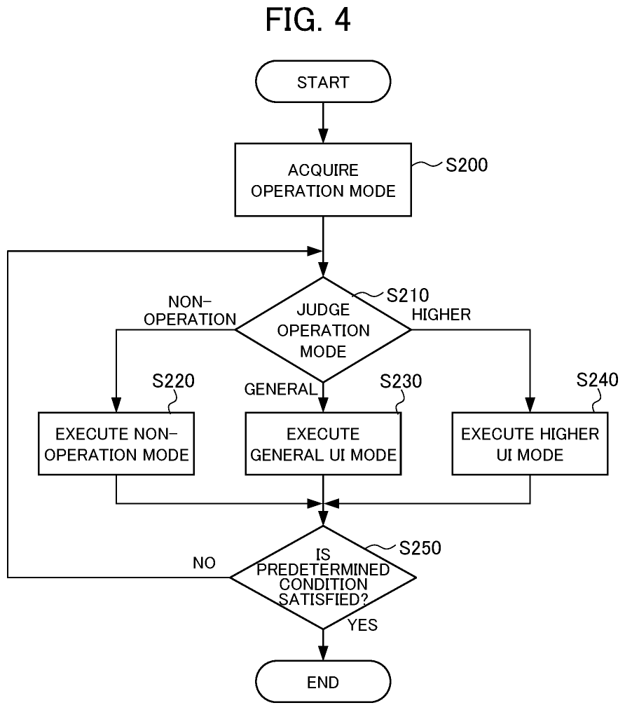

Next, data processing by the mode-specific data processing unit 14 will be described with reference to FIG. 4. FIG. 4 is a flowchart exemplifying a flow of mode-specific data processing. In the mode-specific data processing, an operation mode according to a result of the face authentication process described with reference to FIG. 3 is selected and executed.

When the processing is started, the mode-specific data processing unit 14 acquires an operation mode from the positive authentication processing unit 12 or the non-positive authentication processing unit 13 (step S200) and judges the operation mode (step S210). If judging that the operation mode is the non-operation mode at step S210 (step S210: non-operation), the mode-specific data processing unit 14 executes the non-operation mode in which an image of the monitoring camera 2 is not displayed to the user, and the user is not allowed to access the functions of the camera management apparatus 1 (step S220). If judging that the operation mode is the general mode at step S210 (step S210: general), the mode-specific data processing unit 14 executes display of the UI in the general mode (step S230). If judging that the operation mode is the higher mode at step S210 (step S210: higher), the mode-specific data processing unit 14 executes display of the UI in the higher mode (step S240). The mode-specific data processing unit 14 executes the process at and after S210 until a predetermined condition is satisfied (step S250: NO). If judging that the predetermined condition is satisfied, the mode-specific data processing unit 14 ends the processing.

According to the above mode-specific data processing, the camera management apparatus 1 operates in an operation mode according to a result of the face authentication process. Then, if the predetermined condition is satisfied, that is, if a predetermined time has elapsed in the non-operation mode or, during operation in the general mode, if a person detection by the non-positive authentication process is not performed even if the predetermined time has elapsed, the processing ends. Therefore, since it is possible to cause the camera management apparatus 1 to operate in an appropriate operation mode corresponding to a user, required security can be ensured.

According to the camera management apparatus 1 of the present embodiment described above, by continuing the second authentication process at a level different from the level of the first authentication process, for a user who has passed the first authentication process once, it becomes possible to keep the state of the first authentication process having been performed, as far as possible, to ensure the convenience for the user.

The information processing apparatus of the present disclosure has been described as the camera management apparatus 1 for managing the monitoring camera 2 in the present embodiment but is not limited thereto. The information processing apparatus of the present disclosure can be applied to management of access authority for various apparatuses other than a monitoring camera.

In the present specification, information acquired at the first timing is defined as first biometric information. Further, information acquired at the second timing after the first timing is defined as second biometric information. Both may be the same kind of information (the first biometric information=a face image, the second biometric information=a face image) or may be different kinds of information (the first biometric information=a face image, the second biometric information=a fingerprint image or the like).

Further, in the present specification, a criterion of being judged to have passed by the first authentication process is defined as the first authentication level. Further, a criterion of being judged to have passed by the second authentication process is defined as the second authentication level. Here, if authentication algorithms of the first and second authentication processes are the same (for example, both are for the process of matching with a face image registered in a database in advance), the second authentication level (for example, the matching rate=50%) is lower than the first authentication level (for example, the matching rate=90%). The authentication algorithms for the first and second authentication processes may be different from each other. In this case also, the second authentication level is lower than the first authentication level in the security strength level.

The processing unit 10 may be adapted to continue operation in the higher mode, if the second authentication level is reached even though the first authentication level is not reached as a result of the non-positive authentication process.

According to the above, a user who has been authenticated for the higher mode once can continuously be provided with the higher mode by the non-positive authentication process, and the convenience for the user is improved.

If the second authentication level is not reached as a result of the non-positive authentication process, the processing unit 10 may instruct the camera management apparatus 1 to operate in the general mode, which is an operation mode for a user who has the second operation authority that is more limitative than the first operation authority.

According to the above, a user who has been provided with the higher mode is continuously provided with the general mode without the positive authentication being required again, and the convenience for the user is improved.

If the second authentication level is not reached as a result of the non-positive authentication process, the processing unit 10 may provide an alert to the user.

According to the above, the user can know that the non-positive authentication process at the second authentication level has not been performed and can take measures so that the non-positive authentication process at the second authentication level can be properly performed. Thus, the convenience for the user is improved.

If the second authentication level is reached as a result of the non-positive authentication process executed within a set time after change to the general mode, the processing unit 10 may instruct the camera management apparatus 1 to operate in the higher mode.

According to the above, even if an operation mode for a user who has been authenticated for the higher mode once is changed to the general mode due to some condition, the operation mode for the user can be resumed to the higher mode without performing the positive authentication process again, and the convenience for the user is improved.

If a state of not reaching the second authentication level continues for a predetermined time as a result of the non-positive authentication process executed after change to the general mode, the processing unit 10 may instruct the camera management apparatus 1 to operate in the non-operation mode.

According to the above, the camera management apparatus 1 operates in the non-operation mode if it becomes impossible for a user to receive provision of the higher mode or the general mode, and security is maintained.

The processing sequence described above can be executed by hardware, and can also be executed by software. In other words, the functional configuration of FIG. 2 is merely an illustrative example, and the present disclosure is not particularly limited thereto. More specifically, the types of functional blocks employed to realize the above-described functions are not particularly limited to the examples shown in FIG. 2, so long as the camera management apparatus 1 can be provided with the functions enabling the aforementioned processing sequence to be executed in its entirety. In addition, a single functional block may be configured by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like. The computer may be a computer equipped with dedicated hardware. In addition, the computer may be a computer capable of executing various functions, e.g., a general-purpose personal computer, by installing various programs.

The storage medium containing such a program can not only be constituted by the removable medium distributed separately from the device main body for supplying the program to a user, but also can be constituted by a storage medium or the like supplied to the user in a state incorporated in the device main body in advance. The removable medium is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM in which the program is recorded or a hard disk included in the storage unit 20, etc.

It should be noted that, in the present specification, the steps defining the program recorded in the storage medium include not only the processing executed in a time series following this order, but also processing executed in parallel or individually, which is not necessarily executed in a time series.

The embodiments of the present disclosure described above are only illustrative, and are not to limit the technical scope of the present disclosure. The present disclosure can assume various other embodiments. Additionally, it is possible to make various modifications thereto such as omissions or replacements within a scope not departing from the spirit of the present disclosure. These embodiments or modifications thereof are within the scope and the spirit of the disclosure described in the present specification, and within the scope of the disclosure recited in the claims and equivalents thereof.

What is claimed is:

1. An information processing apparatus comprising at least one processor,
the at least one processor configured to
execute a first authentication process at a first authentication level based on first biometric information about a user acquired at a first timing;
instruct the information processing apparatus to operate in a first operation mode in a case where a result of the first authentication process reaches the first authentication level and the user corresponding to the first biometric information is judged to have first operation authority;
execute a second authentication process at a second authentication level lower than the first authentication level, based on second biometric information about the user acquired at a second timing during the operation in the first operation mode; and
execute a process according to a result of the second authentication process.

2. The information processing apparatus according to claim 1, wherein the at least one processor is configured to continue the operation in the first operation mode in a case where, as a result of the second authentication process, the second authentication level is reached even though the first authentication level is not reached.

3. The information processing apparatus according to claim 1, wherein the at least one processor is configured to instruct the information processing apparatus to operate in a second operation mode being an operation mode for a user who has second operation authority that is limitative than the first operation authority, in a case where, as a result of the second authentication process, the second authentication level is not reached.

4. The information processing apparatus according to claim 1, wherein the at least one processor is configured to provide an alert to the user in a case where, as a result of the second authentication process, the second authentication level is not reached.

5. The information processing apparatus according to claim 3, wherein the at least one processor is configured to instruct the information processing apparatus to operate in the first operation mode in a case where, as a result of the second authentication process executed within a set time after change to the second operation mode, the second authentication level is reached.

6. The information processing apparatus according to claim 3, wherein the at least one processor is configured to instruct the information processing apparatus to operate in a non-operation mode in a case where, as a result of the second authentication process executed after change to the second operation mode, a state in which the second authentication level is not reached continues for a predetermined time.

7. An information processing method comprising:
causing at least one processor provided in an information processing apparatus
to execute a first authentication process at a first authentication level based on first biometric information about a user acquired at a first timing;
to instruct the information processing apparatus to operate in a first operation mode in a case where a result of the first authentication process reaches the first authentication level and the user corresponding to the first biometric information is judged to have first operation authority;
to execute a second authentication process at a second authentication level lower than the first authentication level, based on second biometric information about the user acquired at a second timing during the operation in the first operation mode; and
to execute a process according to a result of the second authentication process.

8. The information processing method according to claim 7, wherein the at least one processor continues the operation in the first operation mode in a case where, as a result of the second authentication process, the second authentication level is reached even though the first authentication level is not reached.

9. The information processing method according to claim 7, wherein the at least one processor instructs the information processing apparatus to operate in a second operation mode which is an operation mode for a user who has second operation authority that is more limitative than the first operation authority, in a case where, as a result of the second authentication process, the second authentication level is not reached.

10. The information processing method according to claim 7, wherein the at least one processor provides an alert to the user in a case where, as a result of the second authentication process, the second authentication level is not reached.

11. The information processing method according to claim 9, wherein the at least one processor instructs the information processing apparatus to operate in the first operation mode in a case where, as a result of the second authentication process executed within a set time after change to the second operation mode, the second authentication level is reached.

12. The information processing method according to claim 9, wherein the at least one processor instructs the information processing apparatus to operate in a non-operation mode in a case where, as a result of the second authentication process executed after change to the second operation mode, a state in which the second authentication level is not reached continues for a predetermined time.

13. A non-transitory computer-readable recording medium recording a program for causing at least one processor provided in an information processing apparatus to perform operations that comprises:
executing a first authentication process at a first authentication level based on first biometric information about a user acquired at a first timing;
instructing the information processing apparatus to operate in a first operation mode in a case where a result of the first authentication process reaches the first authentication level and the user corresponding to the first biometric information is judged to have first operation authority;
executing a second authentication process at a second authentication level lower than the first authentication level, based on second biometric information about the user acquired at a second timing during the operation in the first operation mode; and
executing a process according to a result of the second authentication process.

14. The non-transitory computer-readable recording medium according to claim 13, wherein the program causes the at least one processor to continue the operation in the first operation mode in a case where, as a result of the second authentication process, the second authentication level is reached even though the first authentication level is not reached.

15. The non-transitory computer-readable recording medium according to claim 13, wherein the program causes the at least one processor to instruct the information processing apparatus to operate in a second operation mode, which is an operation mode for a user who has second operation authority that is more limited than the first operation authority, in a case where, as a result of the second authentication process, the second authentication level is not reached.

16. The non-transitory computer-readable recording medium according to claim 13, wherein the program causes the at least one processor to provide an alert to the user in a case where, as a result of the second authentication process, the second authentication level is not reached.

17. The non-transitory computer-readable recording medium according to claim 15, wherein the program causes the at least one processor to instruct the information processing apparatus to operate in the first operation mode in a case where, as a result of the second authentication process executed within a set time after change to the second operation mode, the second authentication level is reached.

18. The non-transitory computer-readable recording medium according to claim 15, wherein the program causes the at least one processor to instruct the information processing apparatus to operate in a non-operation mode in a case where, as a result of the second authentication process executed after change to the second operation mode, a state in which the second authentication level is not reached continues for a predetermined time.
